(19) United States
(12) Patent Application Publication
(10) Pub. No.: US 2015/0362980 A1
(43) Pub. Date: Dec. 17, 2015

(54) Always-On Processor as a Coprocessor

(71) Applicant: Apple Inc., Cupertino, CA (US)

(72) Inventor: Brijesh Tripathi, Los Altos, CA (US)

(21) Appl. No.: 14/305,835

(22) Filed: Jun. 16, 2014

(51) Int. Cl. G06F 1/32

(52) U.S. Cl. CPC G06F 1/3287; G06F 1/325

(57) ABSTRACT

A system on a chip (SOC) may include a component that remains powered when the remainder of the SOC is powered off. The component may be configured to power up other components of the SOC while keeping the central processing unit (CPU) processors powered down, in order to perform a task assigned to such other component(s). The always-on component may further include a processor, in some embodiments, which may interact with the other components to perform the task. In an embodiment, the processor within the always-on component may execute operating system (OS) software to interact with the other components while the CPU processors are powered down.

### BACKGROUND

1. Technical Field

Embodiments disclosed herein are related to the field of systems on a chip (SOCs) and, more particularly, to an always-on component in an SOC.

2. Description of the Related Art

A variety of electronic devices are now in daily use with consumers. Particularly, mobile devices have become ubiquitous. Mobile devices may include cell phones, personal digital assistants (PDAs), smart phones that combine phone functionality and other computing functionality such as various PDA functionality and/or general application support, tablets, laptops, net tops, smart watches, wearable electronics, etc. Generally, a mobile device may be any electronic device that is designed to be carried by a user or worn by a user. The mobile device is typically battery powered so that it may operate away from a constant electrical source such as an electrical outlet.

Many mobile devices operate in a “standby” mode much of the time. In the standby mode, the device appears to be “off,” in as much as the device is not actively displaying content for the user and/or not actively performing functionality for the user. In the standby mode, much of the device may indeed be powered off. However, in the background, the device may be listening for phone calls or network packets, checking for alarms, reacting to movement, etc.

Because the mobile devices are often operating from a limited supply (e.g. a battery), energy conservation is a key design consideration for the devices. Including a system on a chip (SOC) can aid in energy conservation, since much of the functionality needed in the device can be included in the SOC. In “standby” mode and other low power modes, it is desirable to power down the SOC to eliminate leakage current losses, which are a significant factor in energy consumption in modern integrated circuit technologies. On the other hand, the SOC is needed for some of the standby functionality mentioned above. Optimizing the energy efficiency of an SOC while providing the standby operation is thus a key design feature of SOCs for mobile devices.

### SUMMARY

In an embodiment, an SOC includes a component that remains powered when the remainder of the SOC is powered off (an “always-on” component). The always-on component may be configured to power up other components of the SOC while keeping the central processing unit (CPU) processors powered down, in order to perform a task assigned to such other component(s). For example, a display controller may be powered up to display an image stored in memory. A graphics processing unit (GPU) may be powered up to render an image for display. The always-on component may further include a processor, in some embodiments, which may interact with the other components to perform the task. In an embodiment, the processor within the always-on component may execute operating system (OS) software to interact with the other components while the CPU processors are powered down. Power/energy consumption may be reduced compared to powering up the CPU processors, in cases where the processor in the always-on component is able to cause the task to complete.

### BRIEF DESCRIPTION OF THE DRAWINGS

The following detailed description makes reference to the accompanying drawings, which are now briefly described.

FIG. 1 is a block diagram of one embodiment of an SOC.

FIG. 2 is a block diagram of one embodiment of an always-on component in the SOC.

FIG. 3 is a block diagram illustrating a generic peripheral component and powering the component on to perform a task,

FIG. 4 is a flowchart illustrating operation of one embodiment of the always-on component to interact with the peripheral component in FIG. 3.

FIG. 5 is a block diagram illustrating an example in which a display controller is powered on to display an image.

FIG. 6 is a block diagram illustrating an example in which a GPU is powered on to render an image.

FIG. 7 is a block diagram illustrating an example in which an audio controller is provided a new song in a play list.

FIG. 8 is a block diagram of one embodiment of a system including the SOC shown in FIG. 1.

FIG. 9 is a block diagram of one embodiment of a computer accessible storage medium.

While the embodiments described here may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits and/or memory storing program instructions executable to implement the operation. The memory can include volatile memory such as static or dynamic random access memory and/or nonvolatile memory such as optical or magnetic disk storage, flash memory, programmable read-only memories, etc. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

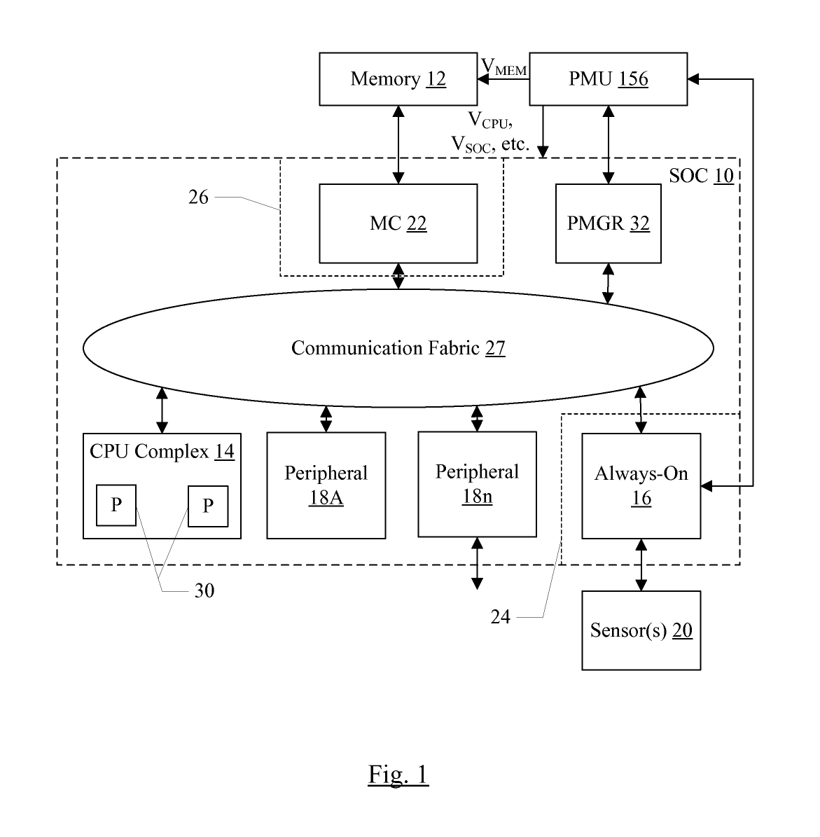

Turning now to FIG. 1, a block diagram of one embodiment of an SOC 10 is shown coupled to a memory 12, at least one sensor 20, and a power management unit (PMU) 156. As implied by the name, the components of the SOC 10 may be integrated onto a single semiconductor substrate as an integrated circuit “chip.” In some embodiments, the components may be implemented on two or more discrete chips in a system. However, the SOC 10 will be used as an example herein. In the illustrated embodiment, the components of the SOC 10 include a central processing unit (CPU) complex 14, an “always-on” component 16, n peripheral components 18A-18n (more briefly, “peripherals 18” or peripheral components 18), a memory controller 22, a power manager (PMGR) 32, and a communication fabric 27. The components 14, 16, 18A-18n, 22, and 32 may all be coupled to the communication fabric 27. The memory controller 22 may be coupled to the memory 12 during use. The PMGR 32 and the always-on component 16 may be coupled to the PMU 156. The PMU 156 may be configured to supply various power supply voltage to the SOC, the memory 12, and/or the sensors 20. The always-on component 16 may be coupled to the sensors 20. In the illustrated embodiment, the CPU complex 14 may include one or more processors (P 30 in FIG. 1). The processors 30 may form the CPU(s) of the SOC 10.

The always-on component 16 may be configured to remain powered up when other components of the SOC 10 (e.g. the CPU complex 14, the peripherals 18A-18n, and the PMGR 32) are powered down. More particularly, the always-on component 16 may be on whenever the SOC 10 is receiving power from the PMU 156. Thus, the always-on component is “always-on” in the sense that it may be powered if the SOC 10 is receiving some power (e.g. at times when the device including the SOC 10 is in standby mode or is operating actively). The always-on component may not be powered when the SOC 10 is not receiving any power (e.g. at times when the device is completely turned off). The always-on component 16 may support certain functions while the remainder of the SOC 10 is off, allowing low power operation.

In FIG. 1, a dotted line 24 separating the always-on component 16 from the other components may indicate an independent power domain for the always-on component 16. Similarly, in the illustrated embodiment, a dotted line 26 may represent an independent memory controller power domain for the memory controller 22. Other components, groups of components, and/or subcomponents may have independent power domains as well. Generally, a power domain may be configured to receive supply voltage (i.e. be powered on) or not receive supply voltage (i.e. be powered off) independent of other power domains. In some embodiments, power domains may be supplied with different supply voltage magnitudes concurrently. The independence may be provided in a variety of fashions. For example, the independence may be provided by providing separate supply voltage inputs from the PMU 156, by providing power switches between the supply voltage inputs and components and controlling the power switches for a given domain as a unit, and/or a combination of the above. There may be more power domains than those illustrated in FIG. 1 as well. For example, the CPU complex 14 may have an independent power domain (and each CPU processor 30 may have an independent power domain as well) in an embodiment. One or more peripheral components 18A-18n may have independent power domains, in an embodiment.

In an embodiment, the always-on component 16 may be configured to wake one or more peripheral components 18A-18n during a time that the CPU processors 30 are powered down. The peripheral components 18A-18n may perform work that the CPU processors 30 have assigned to the peripheral components 18A-18n prior to the CPU processors 30 being powered down. For example, the work may be described in data structures stored in the memory 12 (and thus the memory controller 22 may also be powered up to permit access to the memory 12). The always-on component 16 may be configured to provide information identifying the data stored in memory (e.g. pointer(s) to the data structures) to the peripheral components 18A-18n so that the peripherals may perform the work. Once the work is complete, the peripheral components 18A-18n may be returned to sleep (as may the memory controller 22).

As illustrated in FIG. 1, the always-on component 16 may be coupled to at least one sensor 20 (and may be coupled to multiple sensors 20). The always-on component 16 may be configured to read the sensor data from the sensors 20 while the SOC 10 is powered off (in addition to the times when the SOC 10 is powered on). The always-on component 16 may include a memory (not shown in FIG. 1) to buffer the sensor data, and the remainder of the SOC 10 need not be powered up unless the memory (or a portion of the memory allocated to store sensor data) fills with data (or reaches a threshold level of fullness). In some embodiments, the always-on component 16 may be configured to process the sensor data in some fashion as well. For example, the always-on component 16 may be configured to filter the sensor data. Filtering data may generally refer to one or more of: searching for a pattern or other data properties that indicate that the sensor data should be further processed by the processors in the CPU complex 14; manipulating the data to detect/remove noise in the data; further processing data that appears to match a pattern or other property to eliminate false positive matches; etc.

The sensors 20 may be any devices that are configured to detect or measure aspects of the physical environment of a device that includes the sensors. For example, a sensor may include an accelerometer which measures acceleration of the device. An accelerometer may be directional (measuring acceleration in a predetermined direction) or vector (measuring acceleration in multiple dimensions and producing a vector indicating the acceleration and its direction). Multiple directional accelerometers may be employed to permit vector acceleration sensing as well as directional acceleration sensing. Another example of a sensor may be gyroscope (or gyro). The gyroscope may be used to detect the orientation of the device and/or changes in orientation. Like the accelerometer, the gyroscope may be directional or multidimensional, and/or multiple directional gyroscopes may be used. Yet another sensor may be a magnetometer, which may be used to measure magnetic orientation and thus may be used to form a compass. In other embodiments, the compass functionality may be embedded in the sensor. Another sensor may be an audio detector (e.g. a microphone). The audio detector may capture sound and generate data indicative of the sound. Another sensor may be a photodetector that detects light or other electromagnetic energy. Other exemplary sensors may include an altimeter to detect altitude, a temperature sensor, and/or a pressure sensor. Still another sensor may be a user interface device such as a button, a touch screen, a keyboard, a pointing device, a camera, etc. Any set of sensors may be employed.

As mentioned above, the always-on component 16 may be configured to buffer data in a memory within the component. If the buffer is nearing full, the always-on component 16 may be configured to wake the memory controller 22 in order to write the sensor data to the memory 12. In some embodiments, the always-on component 16 may be configured to write results of filtering the data to the memory 12. In some embodiments, the always-on component 16 may perform other processing tasks while the rest of the SOC 10 is powered down. To the extent that these tasks access the memory 12, the always-on component 16 may be configured to wake the memory controller 22. In addition, the always-on component 16 may be configured to wake at least a portion of the communication fabric 27 (i.e. the portion that connects the always-on component 16 to the memory controller 22).

Using this memory-only communication mode, the always-on component 16 may be able to access the memory 12 and take advantage of the significant storage available in the memory 12 while expending a relatively low amount of energy/power, since the remainder of the SOC 10 remains powered down. The always-on component 16 may store programmable configuration data for the memory controller 22, so that the always-on component 16 may program the memory controller 22 once power is restored. That is, the always-on component 16 may be configured to program the memory controller 22 in a manner similar to the way the operating system would program the memory controller 22 during boot of the device including the SOC 10. The programmable configuration data stored by the always-on component 16 may be the configuration data that was in the memory controller 22 when the SOC 10 (except for the always-on component 16) was most recently powered down, in one embodiment. In another embodiment, the programmable configuration data may be a configuration that is known to work for any previous configuration of the memory controller 22 and/or any configuration of the memory 12. The known-good configuration may, e.g., be a configuration that is acceptable in performance for the memory accesses by the always-on component 16.

When the SOC 10 is powered down with the always-on component 16 remaining powered, part of the power down sequence may be to place the memory 12 in a retention mode. For example, for dynamic random access memory (DRAM) embodiments of the memory 12, the retention mode may be a “self-refresh” mode. In retention mode, the memory 12 may not be externally accessible until the mode is changed. However, the contents of the memory 12 may be preserved. For example, in the self-refresh mode, the DRAM may perform the periodic refreshes needed to retain data (which are normally performed by the memory controller 22, when the memory controller 22 is powered on).

In some embodiments, the always-on component 16 may store programmable configuration data for other components in the SOC 10. The programmable configuration data may reflect the state of the components at the time that the remainder of the SOC 10 was most recently powered down. The always-on component 16 may be configured to wake the SOC 10 for processing, and may reprogram the components with the stored programmable configuration data. The process of restoring state to the components based on the stored programmable configuration data may be referred to as reconfiguration. Again, similar to the memory-only communication mode discussed above, the state that is restored to the components may be the state at the most recent power down of the component or may be a known-good state with acceptable performance for restarting the SOC 10 for operation. In the latter case, the state may be modified to a higher performance state after the reconfiguration has completed.

The always-on component 16 may be configured to communicate with the PMU 156, in addition to the communication of the PMGR 32 to the PMU 156. The interface between the PMU 156 and the always-on component 16 may permit the always-on component 16 to cause components to be powered up (e.g. the memory controller 22, or the other components of the SOC 10) when the PMGR 32 is powered down. The interface may also permit the always-on component 16 to control its own power state as well.

Generally, a component may be referred to as powered on or powered off. The component may be powered on if it is receiving supply voltage so that it may operate as designed. If the component is powered off, then it is not receiving the supply voltage and is not in operation. The component may also be referred to as powered up if it is powered on, and powered down if it is powered off. Powering up a component may refer to supplying the supply voltage to a component that is powered off, and powering down the component may refer to terminating the supply of the supply voltage to the component. Similarly, any subcomponent and/or the SOC 10 as a whole may be referred to as powered up/down, etc. A component may be a predefined block of circuitry which provides a specified function within the SOC 10 and which has a specific interface to the rest of the SOC 10. Thus, the always-on component 16, the peripherals 18A-18n, and the CPU complex 14, the memory controller 22, and the PMGR 32 may each be examples of a component.

A component may be active if it is powered up and not clock gated. Thus, for example, a processor in the CPU complex 14 may be available for instruction execution if it is active. A component may be inactive if it is powered off or in another low power state in which a significant delay may be experienced before instructions may be executed. For example, if the component requires a reset or a relock of a phase lock loop (PLL), it may be inactive even if it remains powered. A component may also be inactive if it is clock gated. Clock gating may refer to techniques in which the clock to the digital circuitry in the component is temporarily “turned off,” preventing state from being captured from the digital circuitry in clocked storage devices such as flops, registers, etc.

Generally, a component may wake another component if that other component is inactive. Waking the component may include powering the component up (if the component is powered down) and restoring state to the component. Waking may further include causing the component to begin operation, e.g. on a particular item of work. An inactive component may be referred to as being asleep. When an active component is put to sleep, it may become inactive.

As mentioned above, the CPU complex 14 may include one or more processors 30 that may serve as the CPU of the SOC 10. The CPU of the system includes the processor(s) that execute the main control software of the system, such as an operating system (OS). Generally, software executed by the CPU during use may control the other components of the system to realize the desired functionality of the system. The processors may also execute other software, such as application programs. The application programs may provide user functionality, and may rely on the operating system for lower-level device control, scheduling, memory management, etc. Accordingly, the processors may also be referred to as application processors. The CPU complex 14 may further include other hardware such as an L2 cache and/or an interface to the other components of the system (e.g. an interface to the communication fabric 27).

An operating point may refer to a combination of power supply voltage magnitude and operating frequency for the CPU complex 14, the always-on component 16, other components of the SOC 10, etc. The operating frequency may be the frequency of the clock that clocks the component. The operating frequency may also be referred to as the clock frequency or simply the frequency. The operating point may also be referred to as an operating state or power state. The operating point may be part of the programmable configuration data that may be stored in the always-on component 16 and reprogrammed into the components when reconfiguration occurs.

Generally, a processor may include any circuitry and/or microcode configured to execute instructions defined in an instruction set architecture implemented by the processor. Processors may encompass processor cores implemented on an integrated circuit with other components as a system on a chip (SOC 10) or other levels of integration. Processors may further encompass discrete microprocessors, processor cores and/or microprocessors integrated into multichip module implementations, processors implemented as multiple integrated circuits, etc.

The memory controller 22 may generally include the circuitry for receiving memory operations from the other components of the SOC 10 and for accessing the memory 12 to complete the memory operations. The memory controller 22 may be configured to access any type of memory 12. For example, the memory 12 may be static random access memory (SRAM), dynamic RAM (DRAM) such as synchronous DRAM (SDRAM) including double data rate (DDR, DDR2, DDR3, DDR4, etc.) DRAM. Low power/mobile versions of the DDR DRAM may be supported (e.g. LPDDR, mDDR, etc.). The memory controller 22 may include queues for memory operations, for ordering (and potentially reordering) the operations and presenting the operations to the memory 12. The memory controller 22 may further include data buffers to store write data awaiting write to memory and read data awaiting return to the source of the memory operation. In some embodiments, the memory controller 22 may include a memory cache to store recently accessed memory data. In SOC implementations, for example, the memory cache may reduce power consumption in the SOC by avoiding reaccess of data from the memory 12 if it is expected to be accessed again soon. In some cases, the memory cache may also be referred to as a system cache, as opposed to private caches such as the L2 cache or caches in the processors, which serve only certain components. Additionally, in some embodiments, a system cache need not be located within the memory controller 22.

The peripherals 18A-18n may be any set of additional hardware functionality included in the SOC 10. For example, the peripherals 18A-18n may include video peripherals such as an image signal processor configured to process image capture data from a camera or other image sensor, display controllers configured to display video data on one or more display devices, graphics processing units (GPUs), video encoder/decoders, scalers, rotators, blenders, etc. The peripherals may include audio peripherals such as microphones, speakers, interfaces to microphones and speakers, audio processors, digital signal processors, mixers, etc. The peripherals may include interface controllers for various interfaces external to the SOC 10 (e.g. the peripheral 18n) including interfaces such as Universal Serial Bus (USB), peripheral component interconnect (PCI) including PCI Express (PCIe), serial and parallel ports, etc. The peripherals may include networking peripherals such as media access controllers (MACs). Any set of hardware may be included.

The communication fabric 27 may be any communication interconnect and protocol for communicating among the components of the SOC 10. The communication fabric 27 may be bus-based, including shared bus configurations, cross bar configurations, and hierarchical buses with bridges. The communication fabric 27 may also be packet-based, and may be hierarchical with bridges, cross bar, point-to-point, or other interconnects.

The PMGR 32 may be configured to control the supply voltage magnitudes requested from the PMU 156. There may be multiple supply voltages generated by the PMU 156 for the SOC 10. For example, illustrated in FIG. 1 are a V_{CPU} and a V_{SOC}. The V_{CPU} may be the supply voltage for the CPU complex 14. The V_{SOC} may generally be the supply voltage for the rest of the SOC 10 outside of the CPU complex 14. For example, there may be separate supply voltages for the memory controller power domain and the always-on power domain, in addition to the V_{SOC} for the other components. In another embodiment, V_{SOC} may serve the memory controller 22, the always-on component 16, and the other components of the SOC 10 and power gating may be employed based on the power domains. There may be multiple supply voltages for the rest of the SOC 10, in some embodiments. In some embodiments, there may also be a memory supply voltage for various memory arrays in the CPU complex 14 and/or the SOC 10. The memory supply voltage may be used with the voltage supplied to the logic circuitry (e.g. V_{CPU} or V_{SOC}), which may have a lower voltage magnitude than that required to ensure robust memory operation. The PMGR 32 may be under direct software control (e.g. software may directly request the power up and/or power down of components) and/or may be configured to monitor the SOC 10 and determine when various components are to be powered up or powered down.

The PMU 156 may generally include the circuitry to generate supply voltages and to provide those supply voltages to other components of the system such as the SOC 10, the memory 12 (V_{MEM} in FIG. 1), various off-chip peripheral components (not shown in FIG. 1) such as display devices, image sensors, user interface devices, etc. The PMU 156 may thus include programmable voltage regulators, logic to interface to the SOC 10 and more particularly the PMGR 32 to receive voltage requests, etc.

It is noted that the number of components of the SOC 10 (and the number of subcomponents for those shown in FIG. 1, such as within the CPU complex 14) may vary from embodiment to embodiment. There may be more or fewer of each component/subcomponent than the number shown in FIG. 1.

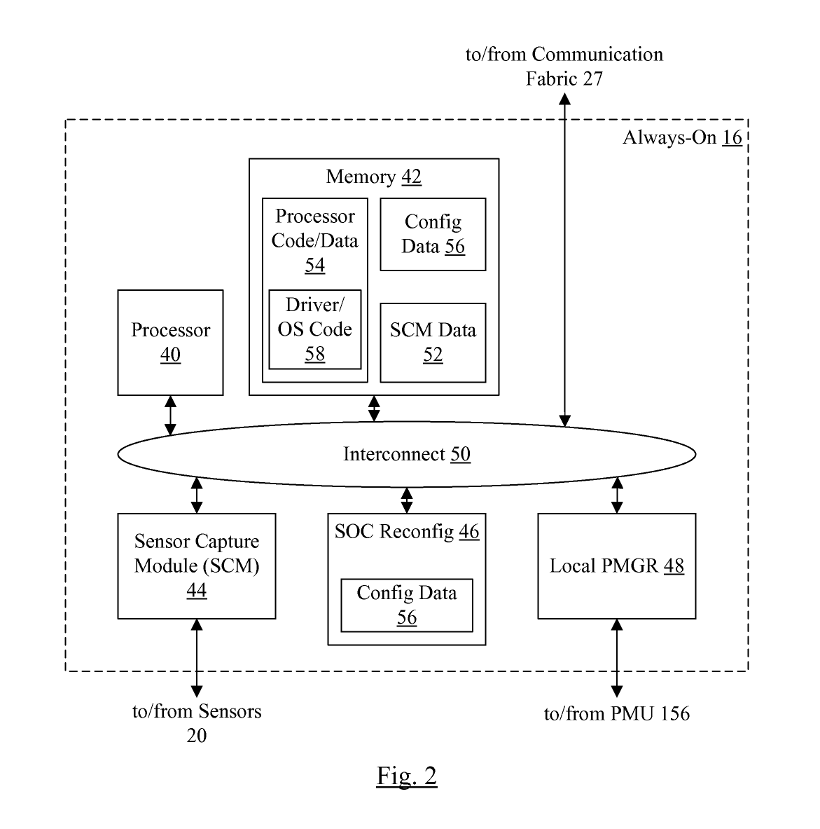

Turning now to FIG. 2, a block diagram of one embodiment of the always-on component 16 is shown. In the illustrated embodiment, the always-on component 16 may include a processor 40, a memory 42, a sensor capture module (SCM) 44, an SOC reconfiguration circuit 46, a local PMGR 48, and an interconnect 50. The processor 40, the memory 42, the SCM 44, the SOC reconfiguration circuit 46, and the local PMGR 48 are coupled to the interconnect 50. The SCM 44 may also be referred to as a sensor capture unit or a sensor capture circuit.

In this embodiment, the processor 40 may be configured to wake up a peripheral component to perform work assigned to the peripheral component by the OS/CPU processors 30. The processor 40 may be configured to execute software code to perform the wake up, in conjunction with other hardware such as the SOC reconfiguration circuit 46 and the local PMGR 48. For example, in response to determining that a peripheral component is to be awakened to perform an assigned task, the processor 40 may request, through the local PMGR 48, that the peripheral component be powered (as well as the memory controller 22 assuming that the task will access the memory 12). The processor 40 may further request a power up of the communication fabric 27, or a portion thereof to be used in performing the task (e.g. the portion that connects the memory controller 22, the peripheral, and the always-on component 16). The SOC reconfiguration circuit 46 may restore the programmable configuration data to the memory controller 22, the fabric 27, and the peripheral component 18. The processor 40 may interact with the restored memory controller 22 and peripheral component 18 to perform the desired task, after which the processor 40 may cause the memory controller 22 and the peripheral component 18 to return to sleep and the communication fabric 27 may be powered down.

The processor 40 may determine that a given peripheral component 18A-18n is to be awakened in a variety of ways. A timer may be used, for example, to periodically wake a peripheral component. A signal received from an external device (e.g. one of the sensors 20) may be used.

As mentioned above, the processor 40 may execute code to implement various operations. Code may be multiple instructions which, when executed on the processor 40, cause the desired operation to occur. The code may include the processor code 54 illustrated in FIG. 2. More particularly, the processor code 54 may include driver code for the peripheral component 18, the memory controller 22, etc. The driver code may be similar to the driver code used by the OS executed by the CPU processors 30. Alternatively, the processor code 54 may include an OS, which may be similar to the OS executed by the CPU processors 30 or may be a different version (e.g. reduced in size and complexity as compared to the OS executed by the CPU processors 30). In yet another alternative, the processor code 54 may be custom code written to be executed by the processor 40. Any combination of the above examples may be used.

The sensor capture module 44 may be coupled to the sensors 20 when the SOC 10 is included in a system, and may be configured to capture data from the sensors 20. In the illustrated embodiment, the sensor capture module 44 may be configured to write the captured sensor data to the memory 42 (SCM Data 52). The memory 42 may be an SRAM, for example. However, any type of memory may be used in other embodiments.

The SCM data 52 may be stored in locations that are preallocated by the always-on component 16 to store captured sensor data. As the locations are consumed, the amount of available memory to store captured data decreases. The sensor capture module 44 may be programmed with a watermark or other indication of fullness in the allocation memory area (generally, e.g., a “threshold”), and the sensor capture module 44 may be configured to wake the memory controller 22 to write the captured sensor data to memory 12. Alternatively, the processor 40 may be configured to write the captured sensor data to memory 12. In such a case, the sensor capture module 44 may be configured to wake the processor 40.

The processor 40 may be configured to execute the processor code 54 in response to sensor wake ups as well. The code may include filter code which may be executed by the processor 40 to filter the SCM data 52, as discussed above. Responsive to detecting a desired pattern or other data attribute(s) in the SCM data 52, the processor 40 may be configured to wake the memory controller 22 to update the memory 12 and/or to wake the SOC 10.

The processor code/data 54 may be initialized upon boot of a device including the SOC 10. The code may be stored in a non-volatile memory on the SOC 10 or elsewhere in the device, and may be loaded into the memory 42, for example. A local non-volatile memory such as read-only memory (ROM) may also be used in some embodiments.

In an embodiment, the processor 40 may be a smaller, more power efficient processor than the CPU processors 30 in the CPU complex 14. Thus, the processor 40 may consume less power when active than the CPU processors 30 consume. There may also be fewer processors 40 than there are CPU processors 30, in an embodiment.

The SOC reconfiguration circuit 46 may be configured to store the programmable configuration data 56 for the memory controller 22 and the other components of the SOC 10, to reprogram various components responsive to powering the components back up from a powered off state. Alternatively, the programmable configuration data 56 may be stored in the memory 42, or in a combination of the memory 42 and the SOC reconfiguration circuit 46. The configuration data 56 may be written to the circuit 46 by the CPU processors 30, e.g. as part of programming the corresponding component. That is, the CPU processors 30 (executing operating system software, for example, as part of the boot of the device and/or at other times when the configuration is changed) may write the data to the SOC reconfiguration circuit 46. Alternatively, in some embodiments, the SOC reconfiguration circuit 46 may have hardware that monitors and shadows the configuration state. In some embodiments, at least a portion of the programmable configuration data 56 may be predetermined and may be stored in a non-volatile memory such as a ROM, rather than being written to the memory 42 and/or the SOC reconfiguration circuit 46.

In an embodiment, the SOC reconfiguration circuit 46 may include logic circuitry configured to process the programmable configuration data 56 and to write the data to the corresponding components in the SOC 10 after the SOC 10 is powered up again. The programmable configuration data 56 may include a series of register addresses to be written and the data to write to those registers. In some embodiments, the programmable configuration data 56 may further include read commands to read registers, e.g. polling for an expected value that indicates that the initialization performed by various writes is complete and/or the corresponding state is in effect in the component. The expected value may be the entire value read, or may be a portion of the value (e.g. the expected value may include a value and a mask to be applied to the read value prior to comparison). In some embodiments, the programmable configuration data 56 may further include read-modify-write commands to read registers, modify a portion of the read data, and write the modified data back to the register. For example, a second mask may be used to determine which portion of the register value is to be updated. The portion of the register masked by the second mask may not be updated when the value is written to the register.

In another embodiment, the SOC reconfiguration circuit 46 may include another processor and corresponding memory storing code for the processor (or the code may also be stored in the memory 42). The code, when executed by the processor, may cause the processor to configure the various components in the SOC 10 with the programmable configuration data 56. The code may implement the polling features described above as part of the structure of the code itself, or the programmable configuration data 56 may store the address to poll and the expected value, similar to the above discussion. In another embodiment, the processor 40 may execute software to implement the SOC reconfiguration circuit 46.

The programmable configuration data 56 may include data for the memory controller 22, separate data for peripheral components of the SOC 10 that may be awakened without powering up the CPU complex 14, separate data for other components of the SOC 10, and separate data for the reconfiguring the processor 40 when it is powered up. When powering up the memory controller 22 while the remainder of the SOC 10 is powered down, the data for the memory controller 22 may be processed. The data may include programmable configuration data for the memory controller 22. The data may further include additional programmable configuration data, in an embodiment. For example, programmable configuration data for the communication fabric 27 may be included. Programmable configuration data may be included for whichever components are used in communication between the always-on component 16 and the memory controller 22. Similarly, data for other components that may be powered up while the CPU complex 14 is powered down may be processed when such events occur. When powering up the remainder of the SOC 10, the data for the other components may be processed. Similarly, when powering up the processor 40, the programmable configuration data for the processor 40 may be processed.

The local PMGR 48 may be configured to handle power management functions within the always-on component 16, in a manner similar to the PMGR 32 in FIG. 1 for the SOC 10 as a whole. The always-on component 16 may support multiple power states, and the local PMGR 48 may assist with transitions between those states. The local PMGR 48 may be configured to communicate with the PMU 156 to support state changes, as well as to manage the providing of supply voltages to various components of the SOC 10 as part of waking up or putting to sleep various components.

The interconnect 50 may comprise any interconnect to transmit communications between the various subcomponents shown in FIG. 2, as well as to communicate over the communication fabric 27 with other components of the SOC 10. The interconnect may include any of the examples of the communication fabric 27 discussed above with regard to FIG. 1, as desired, in various embodiments.

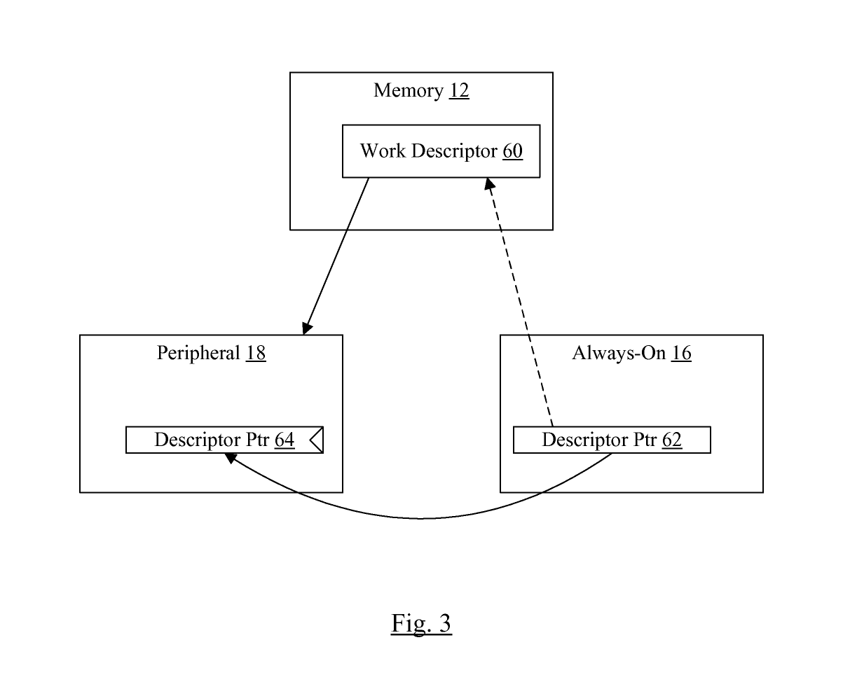

FIG. 3 is a block diagram of a generic example of a component 18 (e.g. any of the components 18A-18n) that may be implemented by one embodiment of the SOC 10 and that may awakened to perform a task while the CPU processors 30 remain powered down.

In the illustrated embodiment, the memory 12 is storing a work descriptor 60. The work descriptor 60 may be a data structure that describes the work to be performed by the peripheral component 18. Accordingly, the form and content of the work descriptor 60 may vary depending on the requirements of the particular peripheral component 18. The always-on component 16 may include a pointer to the work descriptor (reference numeral 62). The pointer may be a memory address locating the work descriptor in memory (as indicated by the dotted line in FIG. 3). For example, the pointer may be the base address of the work descriptor 60. As part of waking the peripheral 18 to perform the task specified in the work descriptor 60, the always-on component 16 may be configured to transmit the descriptor pointer to the peripheral 18 (e.g. into a register 64). The descriptor pointer may be part of the programmable configuration data 56 associated with the peripheral component 18, or may be transferred by the processor 40 subsequent to restoring the programmable configuration data, in various embodiments. The peripheral component 18 may use the descriptor pointer to read the work descriptor 60 and perform the work described therein. The work descriptor 60 may include one or more pointers to other memory locations in the memory 12 as part of the data describing the task, in some embodiments.

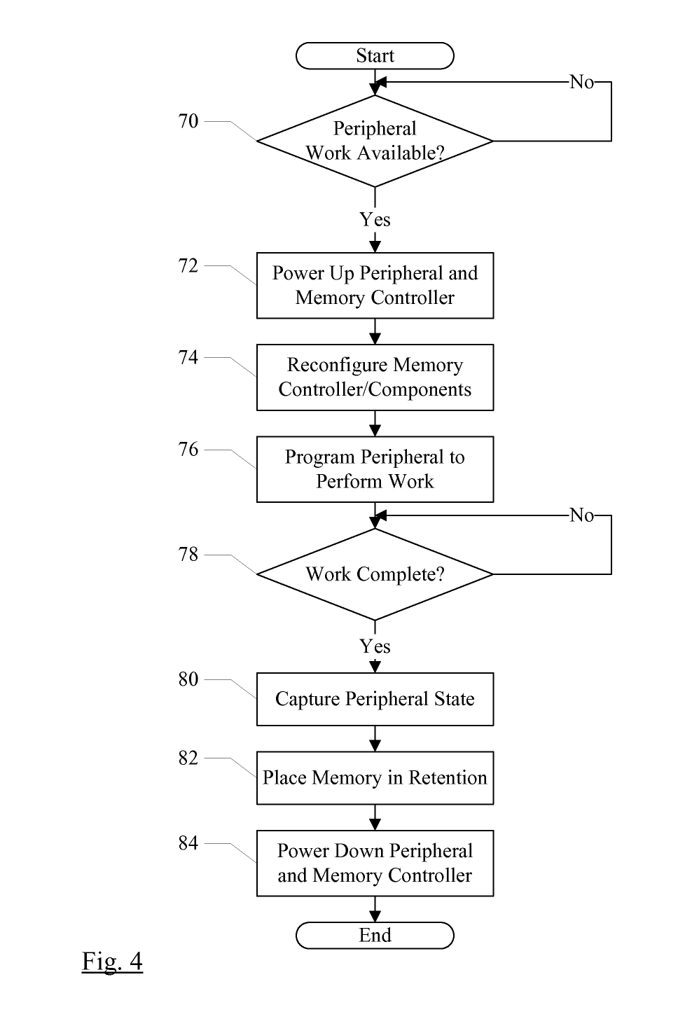

FIG. 4 is a flowchart illustrating operation of one embodiment of the always-on component 16 to wake a peripheral component 18 to perform a task. While the blocks are shown in a particular order for ease of understanding, other orders may be used. Blocks may be performed in parallel in combinatorial logic circuitry within the always-on component 16. Blocks, combinations of blocks, and/or the flowchart as a whole may be pipelined over multiple clock cycles. The always-on component 16 may be configured to implement the operation of FIG. 4. Particularly, in an embodiment, the processor 40 may execute code from the memory 42 to implement a portion or all of the operation in FIG. 4.

The always-on component 16 may determine whether or not there is peripheral work available to be performed (decision block 70). For example, the expiration of a timer associated with a given work descriptor or peripheral may indicate that that the task specified by that work descriptor is ready to be performed. A communication from an external device or sensor may be an indication that there is work to be performed. For example, the user of a mobile device may press the power button or another button on the device, which may cause a lock screen or other visual image to be displayed on a display device included in the mobile device and/or may cause a sound to be emitted by the mobile device. Such tasks may be programmed as work descriptors for peripheral components and may be performed without waking the CPU processor(s) 30. If the user further interacts with the device (e.g. touching the display), the CPU processor(s) 30 may be awakened. In some embodiments, the processor 40 may be configured to perform certain processing related to the user interactions and subsequently wake the CPU processor(s) 30 as needed.

Responsive to detecting that work is available for the peripheral component 18 (decision block 70, “yes” leg), the always-on component 16 may cause the peripheral component 18 to be powered up and may further cause the memory controller 22 to be powered up (block 72). For example, the local PMGR 48 may transmit voltage requests (e.g. in response to communications from the processor 40) to power up the peripheral component 18 and the memory controller 22. In some embodiments, the peripheral component 18 may be in an independent power domain and may be powered up separately. Alternatively, the peripheral component 18 may be in a power domain with other SOC components (but not the CPU complex 14). Once the peripheral component 18 and the memory controller 22 are powered up, the always-on circuit 16 may be configured to reconfigure the memory controller 22, the peripheral component 18, and any other desired components (e.g. the communication fabric 27 or a portion thereof) (block 74). Together, blocks 72 and 74 may be part of waking the peripheral 18/memory controller 22. If the programmable configuration data does not include the data used to locate the work descriptor 60 and perform the task, the always-on circuit 16 may be configured to program the peripheral component 18 to perform the task (block 76). The processor 40 may be configured, via executing code, to program the peripheral component 18 as indicated in block 76.

In some embodiments, the peripheral component 18 may already be awake when the work is available for the peripheral component 18 and thus only the memory controller 22 may need be awakened to perform the assigned task. In some embodiments, the memory controller 22 may already be awake when the work is available for the peripheral component 18 and thus only the peripheral component 18 need be awakened to perform the assigned task. Accordingly, block 72 may generally represent powering up at least one of the memory controller 22 and the peripheral component 18; and block 74 may generally represent reconfiguring at least one of the memory controller 22 and the peripheral component 18.

The always-on component 16 may be configured to await the completion of the task (decision block 78). In an embodiment, the processor 40 may poll the peripheral component 18 for a status indicating completion. Alternatively, the peripheral component 18 may be configured to write a result in the memory 12 and the processor 40 may monitor the result memory location. The peripheral component 18 may be configured to transmit a message and/or interrupt to the always-on component 16/processor 40 to indicate completion.

Responsive to detecting that the work is complete (decision block 78, “yes” leg), the always-on component 16 may optionally capture peripheral component state if needed (block 80). For example, the peripheral state may include programmable configuration data that may have change during performance of the task by the peripheral component 18. The peripheral state may further include state to be written to the memory 12, similar to the operation of the CPU processor(s) 30 prior to powering down the SOC 10 (while the always-on component 16 remains powered). The always-on component 16 may place the memory 12 in retention mode (block 82). For example, the always-on component 16/processor 40 may communicate with the memory controller 22 to place the memory 12 in retention mode. The always-on component 16 may power down the peripheral component 18 and the memory controller 22 (block 84). For example, the processor 40 may communicate to the local PMGR 48 to request power down of the components. In some embodiments, the local PMGR 48 may request a lower power supply voltage for the memory 12 as well, for retention mode.

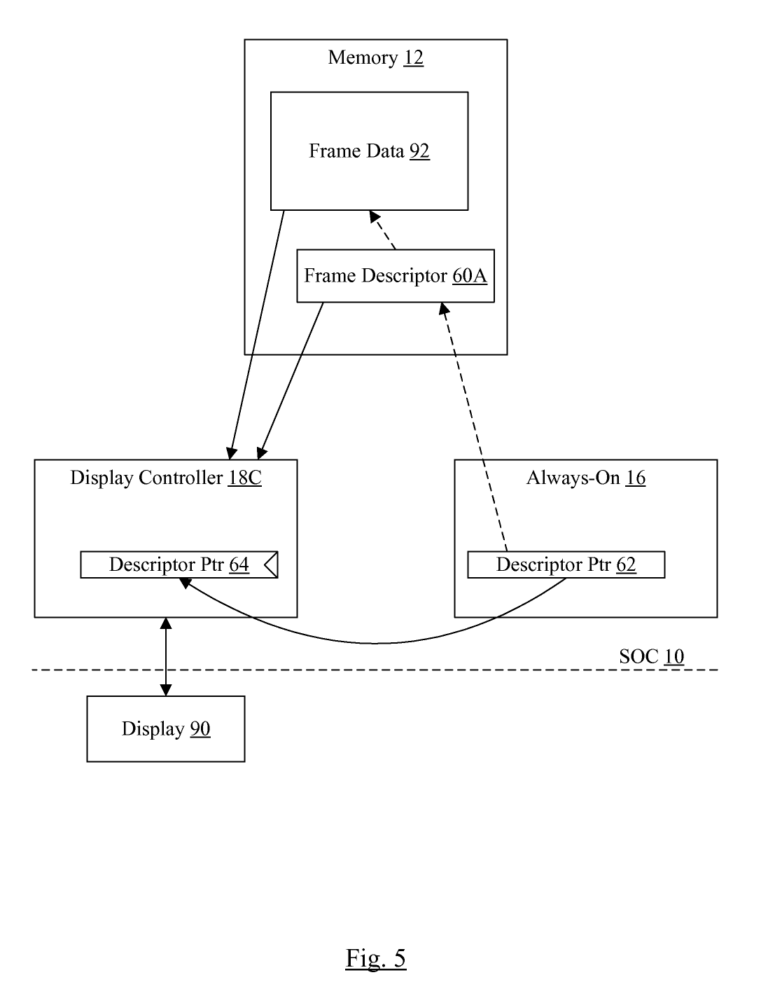

FIG. 5 is a more specific example of an embodiment in which the peripheral component 18 is a display controller 18C coupled to a display device 90. In the illustrated embodiment, the display device 90 may be external to the SOC 10, as illustrated by a dotted line in FIG. 5. In this embodiment, the work descriptor 60 may be a frame descriptor 60A. The frame descriptor 60A may include a pointer to frame data 92, which may describe the pixels of a frame to be displayed on the display device 90. There may be more than one frame, and thus there may be more than one pointer in the frame descriptor 60A (or there may be more than one descriptor pointer and more than one frame descriptor 60A).

The always-on component 16 may supply the descriptor pointer to the display controller 18C, which may be configured to read the frame descriptor 60A and the frame data 92. The frame descriptor 60A may not only include the pointer to the frame data 92, but may also include various parameters describing how the frame is to be displayed. For example, the frame descriptor 60A may include scaling attributes for the frame data, active regions of the frame data that are to be displayed, data describing the pixel format and size of the pixel data (e.g. number of bits/color/pixel), the color space of the pixels, blending to be performed if there is more than one frame, etc.

The display controller 18C may include the circuitry that processes the pixels of the frame data 92 and controls the interface to the display device 90 to display the image represented by the pixels. The display device 90 may be any sort of display (e.g. a liquid crystal display (LCD), thin film transistor (TFT) display, a plasma display, etc.). The display device may include any sort of interface (e.g. red-green-blue, video graphic interface (VGA), high definition media interface (HDMI), display port interface, etc. The display controller 18C may include the circuitry to drive the interface of the display device 90. Once the image has been processed and displayed, the display controller 18C may indicate that the task is complete.

In the embodiment of FIG. 5, the work may be available (e.g. as discussed above with regard to FIG. 4) according to a frame rate or refresh rate for the display device 90 and a timer may be used determine when the work is available. Alternatively or in addition, the work may be available responsive to user input (e.g. pressing the power button on the device that includes the SOC 10).

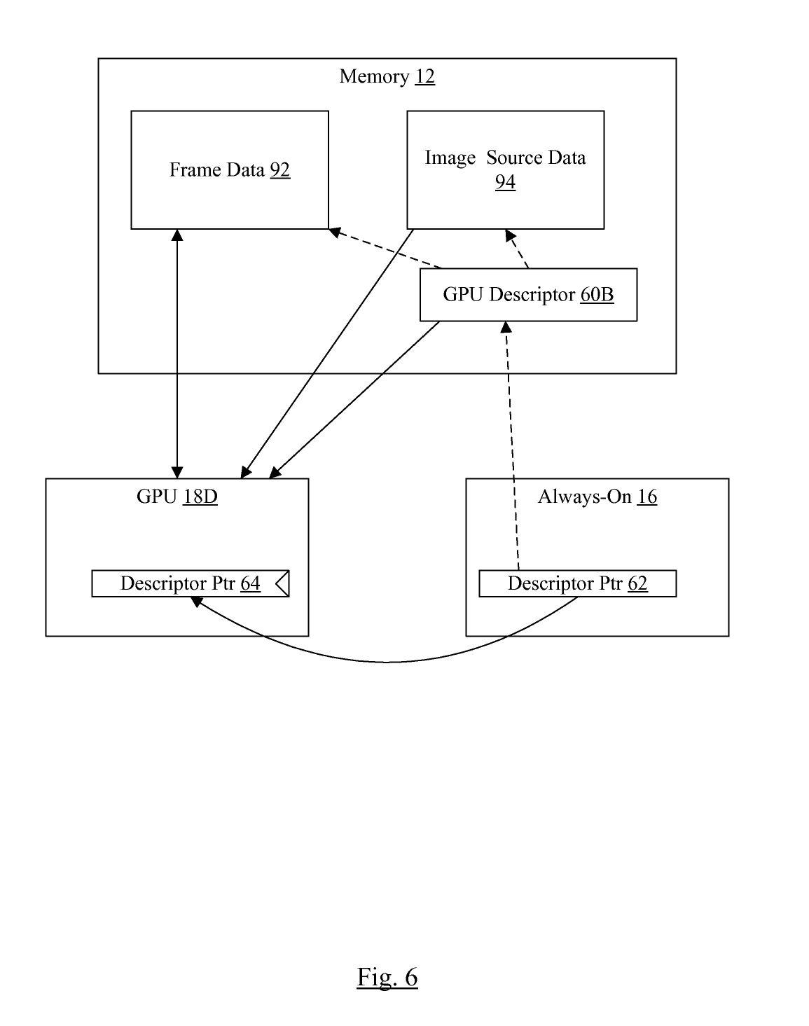

FIG. 6 is a block diagram of another more specific example of an embodiment in which the peripheral component 18 is graphics processing unit (GPU) 18D. In this embodiment, the work descriptor 60 may be a GPU descriptor 60B. The GPU descriptor 60B may include a pointer to one or more sources of image data 94 and a pointer to frame data 92. There may be more than one frame, and thus there may be more than one pointer in the GPU descriptor 60B (or there may be more than one descriptor pointer and more than one GPU descriptor 60B).

Responsive to the descriptor pointer supplied in the register 64 from the always-on component 16, the GPU 18D may be configured to read the GPU descriptor 60B. The GPU 18D may be configured to process the image data from the image source data 94 responsive to the pointer in the GPU descriptor 60B, rendering a frame for display. The GPU 18D may be configured to write the resulting frame data to the frame data 92 responsive to another pointer in the GPU descriptor 60B. In this embodiment, the frame data may be the frame data 92 read by the display controller 18C for display. The GPU descriptor 60B may include data describing the parameters for the rendering (e.g. color space, size of the image, geometry of the image, type and format of the image source data 94, etc.).

The image source data 94 need not specify an entire frame of data. The image source data 94 may be, for example, updates to the frame data 92 and the GPU 18D may render the updates into the frame data 92. The image source data 94 may include descriptions of objects within a frame, for example. The image source data 94 may include still image data or may be frames of a video sequence.

An embodiment may implement both of the examples of FIG. 5 and FIG. 6 to update frames to be displayed and to display those updated frames, without requiring a wakeup on the CPU processors 30. For example, in the case of the user pressing a power button, the device may display a lock screen described in the frame data 92. The lock screen may include the time, and thus the GPU 18D may wake up once per minute to render the time image (e.g. numbers or a clock face) in the frame data 92 to represent the change of time. Other embodiments may wake up once per second if the display includes seconds of time. The display controller 18C may wake up in response to the user pressing the power button, and may display the current time in the frame data 92 as rendered by the GPU 18D.

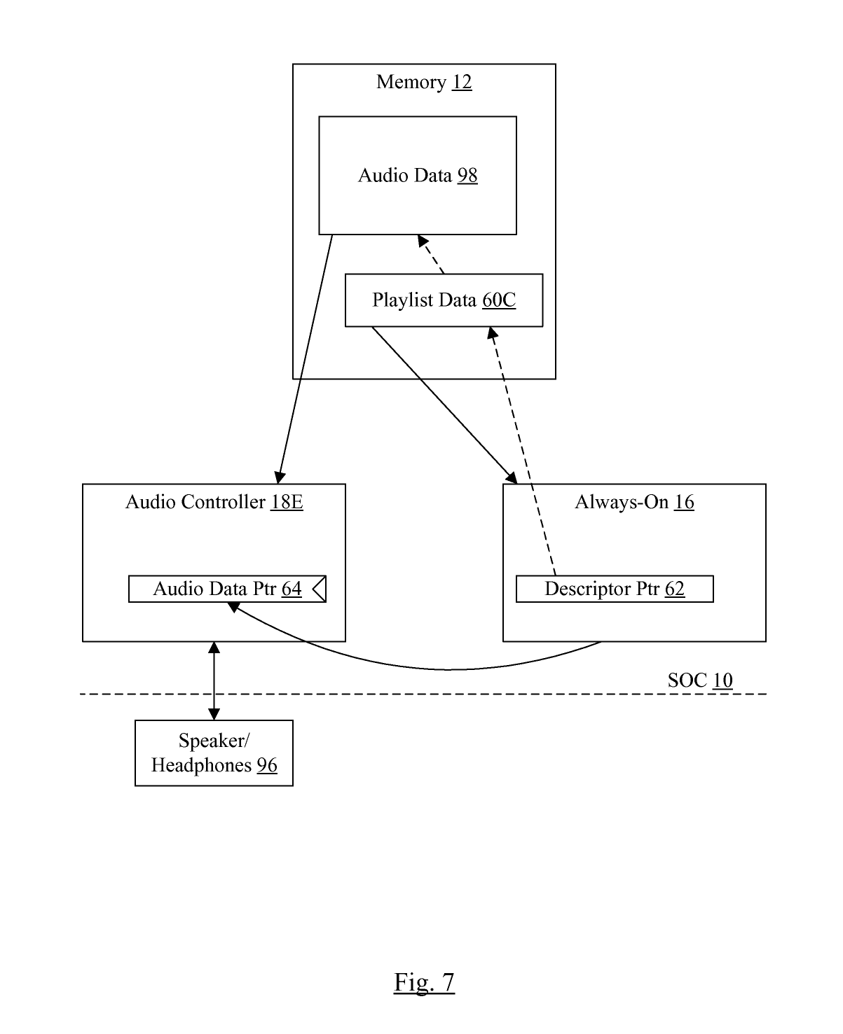

FIG. 7 is a block diagram of yet another more specific example of an embodiment in which the peripheral component 18 is an audio controller 18E coupled to an external speaker and/or headphone jack 96. In this embodiment, the work descriptor 60 may be playlist data 60C. The playlist data 60C may describe a set of audio data including the audio data 98 shown in FIG. 7. Thus, the playlist data 60C may include a series of pointers to audio data, and the sequence in which the audio data should be played. Thus, each audio data 98 may be the data for a song, and the playlist may indicate the order in which the songs are to be played. For example, the order may be fixed, a mechanism used to select order such as random order, etc.

In this embodiment, the descriptor pointer 62 may indicate the playlist data 60C, and the always-on component 16 (and more particularly the processor 40) may process the playlist data to determine the next audio data pointer. The always-on component 16 may program the audio controller 18E (after power up and reconfiguration) with the audio data pointer (e.g. in the register 64). The audio controller 18E may read the audio data, process the data, and control the speaker/headphones to produce the sound represented by the audio data. In another embodiment, the audio controller 18E may be configured to process the playlist data 60C, and the always-on processor 16 may provide the pointer to the playlist data 60C to the audio controller 18E.

The examples of FIGS. 5-7 are not intended to be limiting, and numerous other examples are contemplated. For example, a media access controller (MAC) for a network may be a peripheral component and the always-on component 16 may be configured to periodically transmit “heartbeat” packets or scan received packets for a packet intended to cause the device including the SOC 10 to power up. Any peripheral components and combinations of peripheral components may be used.

Turning next to FIG. 8, a block diagram of one embodiment of a system 150 is shown. In the illustrated embodiment, the system 150 includes at least one instance of the SOC 10 coupled to one or more peripherals 154 and the external memory 12. The PMU 156 is provided which supplies the supply voltages to the SOC 10 as well as one or more supply voltages to the memory 12 and/or the peripherals 154. In some embodiments, more than one instance of the SOC 10 may be included (and more than one memory 12 may be included as well).

The peripherals 154 may include any desired circuitry, depending on the type of system 150. For example, in one embodiment, the system 150 may be a mobile device (e.g. personal digital assistant (PDA), smart phone, etc.) and the peripherals 154 may include devices for various types of wireless communication, such as wifi, Bluetooth, cellular, global positioning system, etc. The peripherals 154 may also include additional storage, including RAM storage, solid state storage, or disk storage. The peripherals 154 may include user interface devices such as a display screen, including touch display screens or multitouch display screens, keyboard or other input devices, microphones, speakers, etc. In the embodiment of FIG. 1, the peripherals 154 may include the sensors 20. In other embodiments, the system 150 may be any type of computing system (e.g. desktop personal computer, laptop, workstation, net top etc.).

The external memory 12 may include any type of memory. For example, the external memory 12 may be SRAM, dynamic RAM (DRAM) such as synchronous DRAM (SDRAM), double data rate (DDR, DDR2, DDR3, etc.) SDRAM, RAMBUS DRAM, low power versions of the DDR DRAM (e.g. LPDDR, mDDR, etc.), etc. The external memory 12 may include one or more memory modules to which the memory devices are mounted, such as single inline memory modules (SIMMs), dual inline memory modules (DIMMs), etc. Alternatively, the external memory 12 may include one or more memory devices that are mounted on the SOC 10 in a chip-on-chip or package-on-package implementation.

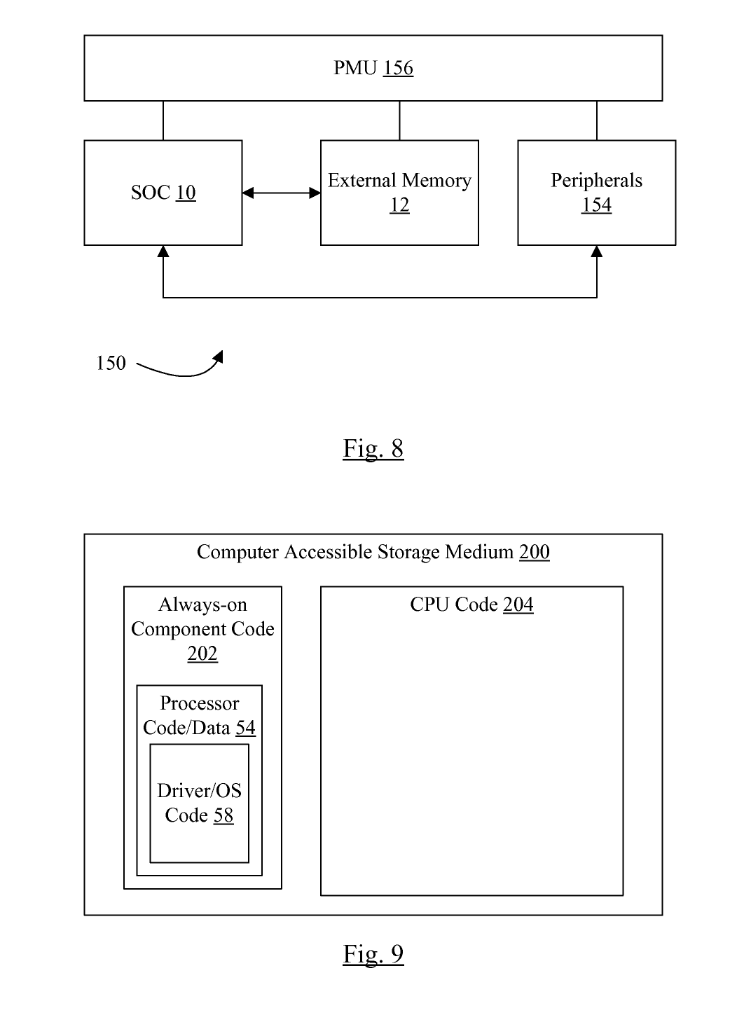

FIG. 9 is a block diagram of one embodiment of a computer accessible storage medium 200. Generally speaking, a computer accessible storage medium may include any storage media accessible by a computer during use to provide instructions and/or data to the computer. For example, a computer accessible storage medium may include storage media such as magnetic or optical media, e.g., disk (fixed or removable), tape, CD-ROM, DVD-ROM, CD-R, CD-RW, DVD-R, DVD-RW, or Blu-Ray. Storage media may further include volatile or non-volatile memory media such as RAM (e.g. synchronous dynamic RAM (SDRAM), Rambus DRAM (RDRAM), static RAM (SRAM), etc.), ROM, or Flash memory. The storage media may be physically included within the computer to which the storage media provides instructions/data. Alternatively, the storage media may be connected to the computer. For example, the storage media may be connected to the computer over a network or wireless link, such as network attached storage. The storage media may be connected through a peripheral interface such as the Universal Serial Bus (USB). Generally, the computer accessible storage medium 200 may store data in a non-transitory manner, where non-transitory in this context may refer to not transmitting the instructions/data on a signal. For example, non-transitory storage may be volatile (and may lose the stored instructions/data in response to a power down) or non-volatile.

The computer accessible storage medium 200 in FIG. 9 may store always-on component code 202. The always-on component code 202 may include instructions which, when executed by the processor 40, implement the operation described for the code above. The always-on component code 202 may include the processor code 54 shown in FIG. 2, for example, including the driver/OS code 58. The computer accessible storage medium 200 in FIG. 9 may further include CPU code 204. The CPU code 204 OS code, as well as various application code. A carrier medium may include computer accessible storage media as well as transmission media such as wired or wireless transmission.

Numerous variations and modifications will become apparent to those skilled in the art once the above disclosure is fully appreciated. It is intended that the following claims be interpreted to embrace all such variations and modifications.

What is claimed is:

1. A system on a chip (SOC) comprising:
at least one first processor forming a central processing unit (CPU);
a peripheral component; and
a first component coupled to the CPU and the peripheral component, wherein the first component is configured to remain powered on during times that the CPU and the peripheral component are powered off, and wherein the first component is configured to wake the peripheral component and interact with the peripheral component to perform at least one task assigned to the peripheral component by the CPU without waking the CPU.

2. The SOC as recited in claim 1 wherein the first component is configured to cause the peripheral component to power down responsive to completing the task.

3. The SOC as recited in claim 1 wherein the peripheral component is a display controller configured to couple to a display device to display an image.

4. The SOC as recited in claim 1 wherein the peripheral component is a graphics processing unit (GPU).

5. The SOC as recited in claim 1 wherein the peripheral component is an audio controller.

6. The SOC as recited in claim 1 wherein the first component comprises at least one second processor and a memory configured to store code executed by the second processor during use, wherein the second processor is configured to interact with the peripheral component responsive to executing the instructions, and wherein the code is operating system code.

7. The SOC as recited in claim 1 wherein the first component comprises at least one second processor and a memory configured to store code executed by the second processor during use, wherein the second processor is configured to interact with the peripheral component responsive to executing the instructions, and wherein the code is driver code for the peripheral component.

8. The SOC as recited in claim 1 further comprising a memory controller coupled to the first component and the peripheral component, wherein the memory controller is configured to couple to a memory, and wherein the memory is configured to store data describing the task, and wherein the first component is further configured to wake the memory controller to perform the task.

9. A method comprising:
a central processing unit (CPU) processor writing data to a memory describing a task to be performed by a peripheral component;
the CPU processor providing a pointer to the data in the memory to a first component;
powering down the CPU processor and the peripheral component;
the first component remaining powered during a time that the CPU processor is powered down;
the first component determining that the task assigned to the peripheral component is to be performed during the time that the CPU processor is powered down;
the first component causing the peripheral component to power up and further causing a memory controller that is coupled to the memory to power up, wherein the first component causes the power up of the peripheral component and the memory controller to perform the task during the time that the CPU processor is powered down responsive to determining that the task is to be performed; and
the first component providing the pointer to the peripheral component to perform the task responsive to powering up the peripheral component.

10. The method as recited in claim 9 further comprising:
the peripheral component performing the task during the time that the CPU processor is powered down; and
powering the peripheral component and the memory controller down responsive to the peripheral component completing the task.

11. The method as recited in claim 10 further comprising placing the memory in a retention mode prior to powering down the memory controller.

12. The method as recited in claim 11 further comprising removing the memory from retention mode prior to providing the pointer to the peripheral component.

13. The method as recited in claim 10 further comprising capturing peripheral state of the peripheral component prior to powering down the peripheral component.

14. The method as recited in claim 9 wherein the first component is configured to store programmable configuration data for the peripheral component and the memory controller, and the method first comprising the first component programming the peripheral component and the memory controller subsequent to the powering up and prior to providing the pointer.

15. A system comprising:
a memory; and
a system on a chip (SOC) coupled to the memory, wherein the SOC includes at least one central processing unit (CPU) processor, a memory controller coupled to the memory, at least one peripheral component, and a first component that is configured to be powered up while a remainder of the SOC is powered off, and wherein the first component is configured to cause a power up at least one of the peripheral component and the memory controller while the CPU processor remains powered down, and wherein the peripheral component is configured to perform an operation while the CPU processor remains powered down.

16. The system as recited in claim 15 wherein the memory is in a self-refresh mode while the memory controller is powered down, and wherein the memory controller is configured to cause the memory to exit the self-refresh mode responsive to the memory controller powering up.

17. The system as recited in claim 16 wherein the peripheral component is configured to read data from the memory describing the operation to be performed.

18. The system as recited in claim 17 wherein the data is written to the memory by the CPU processor prior to the CPU processor powering down.

19. The system as recited in claim 15 further comprising a display device, and wherein the peripheral component is a display controller coupled to the display device.

20. The system as recited in claim 15 wherein the peripheral component is a graphics processing unit (GPU).
